(19) United States
(12) Patent Application Publication
(10) Pub. No.: US 2012/0310942 A1
(43) Pub. Date: Dec. 6, 2012

(54) QUEUING CONFERENCE PARTICIPANTS BY CATEGORY

(75) Inventors: Thomas Richard Haynes, Apex, NC (US); Elizabeth Vera Woodward, Cedar Park, TX (US)

(73) Assignee: INTERNATIONAL BUSINESS MACHINES CORPORATION, Armonk, NY (US)

(21) Appl. No.: 13/152,549

(22) Filed: Jun. 3, 2011

(51) Int. Cl. G06F 17/30

(52) U.S. Cl. 707/740; 707/E17.089

(57) ABSTRACT

A method for queuing conference participants by category includes, with a physical computing system, receiving requests from a number of conference registrants to attend a conference, with the physical computing system, placing each of the registrants into a number of queues based on a category assigned to the registrants, and with the physical computing system, allowing a number of the registrants from the queues to attend the conference such that the conference comprises a number of participants from each of the queues so as to meet predefined criteria.

### BACKGROUND

Aspects of the present invention relate in general to conference management, and more particularly, to placing potential participants of a scheduled conference into queues based on characteristics of those potential participants. Teleconferences and web conferences are often used to conduct business, marketing, and other events. Such conferences may have only a few participants while others may have hundreds or even thousands of participants. At times, a moderator of a web conference or teleconference desires to have an audience that matches certain characteristics. For example, the moderator may wish to have a certain mix of male and female attendees. Alternatively, the moderator may wish to have a certain number of attendees from different geographical locations.

Many teleconference and web conference systems have limitations as to how many people can join a particular conference. For example, if a moderator pays to use a particular teleconference or web conference service, he or she may be allowed only 200 participants for the amount of money he or she is willing to spend. Furthermore, it is difficult to determine how many conference participants will actually show up. Invites may be sent to a number of invitees. The invitations may request that the invitee register for the conference. Typically, even though many invitees may register, only a subset of the total number of registrants will actually attend the conference. Thus, it is often difficult to control the mix of characteristics that will be exhibited by the actual attendees of a conference.

### BRIEF SUMMARY

A method for queuing conference participants by category includes, with a physical computing system, receiving requests from a number of conference registrants to attend a conference, with the physical computing system, placing each of the registrants into a number of queues based on a category assigned to the registrants, and with the physical computing system, allowing a number of the registrants from the queues to attend the conference such that the conference comprises a number of participants from each of the queues so as to meet predefined criteria.

A computing system includes a processor and a memory communicatively coupled to the processor. The processor is configured to receive requests from a number of conference registrants to attend a conference, place each of the registrants into a number of queues based on a category assigned to the registrants, and allow a number of the registrants from the queues to attend the conference such that the conference comprises a number of participants from each of the queues so as to meet predefined criteria.

A computer program product for queuing conference participants includes a computer readable storage medium having computer readable code embodied therewith. The computer readable program code includes computer readable program code configured to receive requests from a number of conference registrants to attend a conference, computer readable program code configured to place each of the registrants into a number of queues based on a category assigned to the registrants, and computer readable program code configured to allow a number of the registrants from the queues to attend the conference such that the conference comprises a number of participants from each of the queues so as to meet predefined criteria.

### BRIEF DESCRIPTION OF THE SEVERAL VIEWS OF THE DRAWINGS

The accompanying drawings illustrate various embodiments of the principles described herein and are a part of the specification. The illustrated embodiments are merely examples and do not limit the scope of the claims.

FIG. 1 is a diagram showing an illustrative physical computing system, according to one example of principles described herein.

FIG. 2 is a flowchart showing an illustrative process for queuing conference participants, according to one example of principles described herein.

FIG. 3 is a diagram showing an illustrative network system which may be used to run an application that queues conference participants, according to one example of principles described herein.

FIG. 4 is a diagram showing an illustrative set of queues for a conference, according to one example of principles described herein.

FIG. 5 is a diagram showing an illustrative set of queues and participants who have been allowed into a conference, according to one example of principles described herein.

FIG. 6 is a diagram showing an illustrative user interface for managing an application for queuing conference participants, according to one example of principles described herein.

FIG. 7 is a flowchart showing an illustrative method for queuing conference participants, according to one example of principles described herein.

Throughout the drawings, identical reference numbers designate similar, but not necessarily identical, elements.

### DETAILED DESCRIPTION

As mentioned above, many teleconference and web conference systems have limitations as to how many people can join a particular conference. For example, if a moderator pays to use a particular teleconference or web conference service, he or she may be allowed only 200 participants for the amount of money he or she is willing to spend. Furthermore, it is difficult to determine how many conference participants will actually show up. Invites may be sent to a number of invitees. The invitations may request that the invitee register for the conference. Typically, even though the invitees may register, only a subset of the total number of registrants will actually attend the conference. Thus, it is often difficult to control the mix of characteristics that will be exhibited by the actual attendees of a conference.

The present specification discloses methods and systems for managing a conference event by placing the registered conference participants who are attempting to access the conference into a queue. According to certain illustrative examples, invitations are sent out to potential conference participants. The invitation requests that the potential participant register for the conference. When a potential participant registers, then the conference management system will obtain information about that potential participant so that he or she may be placed into a particular category based on his or her characteristics. This information may be obtained either by prompting the registrant for the desired information or by retrieving information from a database that may include information about that registrant.

As mentioned above, it is typical that not all of the registrants will actually attend the conference. At the scheduled time of the conference or soon before, the registrants who are actually going to be attending will attempt to access the conference. When a registrant attempts to access the conference, that registrant will be placed into a queue associated with a category in which that registrant was placed based on certain characteristics of that registrant. For example, a registrant may be placed into a category based on his or her profession or skills. Alternatively, a registrant may be placed into a category based on his or her position within a company.

When the conference actually starts, the conference management system will pull the proper number of registrants from each of the category based queues so that the overall mix of characteristics for the conference matches predefined criteria provided by a moderator. For example, a moderator may wish to have a particular representation from a number of different geographic locations. In this case, the different categories associated with the different queues may be based on geographic location. If the moderator prefers a set number of conference participants from each geographical category, then the conference management system will pull that set number from each of the queues. Those who were pulled will be allowed to attend the conference while the remaining participants will not.

Through use of methods and systems embodying principles described herein, a moderator may define the mix of characteristics that he or she desires to be present within a conference such as a web conference or a teleconference. This provides the moderator with more control over the demographics of the meeting. This can be helpful if the subject matter to be presented at the conference is designed for a specific mix of demographics.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Throughout this specification and in the appended claims, the term “conference management system” is to be broadly interpreted as a physical computing system that performs the operations of conference management and queuing of participants as described herein.

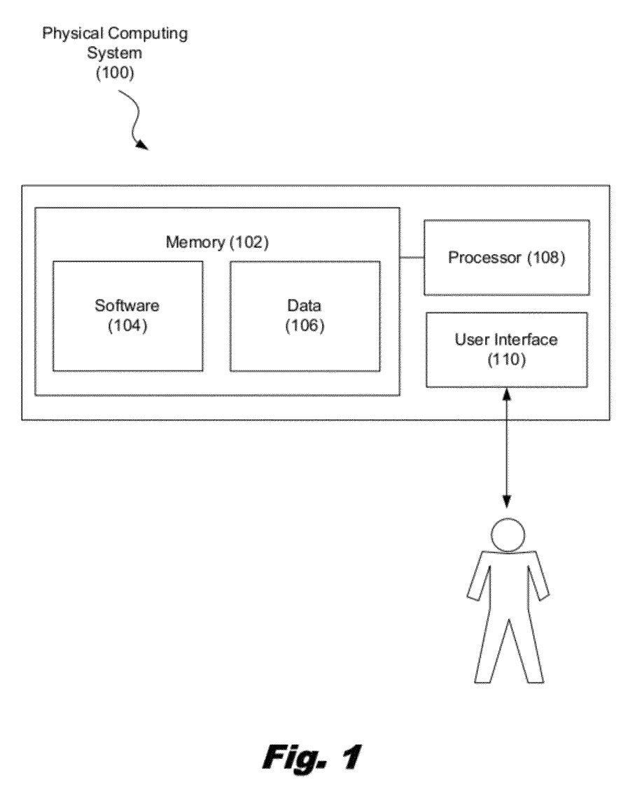

Referring now to the figures, FIG. 1 is a diagram showing an illustrative physical computing system (100) that may be used to queue conference participants. According to certain illustrative examples, the physical computing system (100) includes a memory (102) having software (104) and data (106) stored thereon. The physical computing system (100) also includes a processor (108) and a user interface (110).

There are many types of memory available. Some types of memory, such as solid state drives, are designed for storage. These types of memory typically have large storage volume but relatively slow performance. Other types of memory, such as those used for Random Access Memory (RAM), are optimized for speed and are often referred to as “working memory.” The various forms of memory may store information in the form of software (104) and data (106).

The physical computing system (100) also includes a processor (108) for executing the software (104) and using or updating the data (106) stored in memory (102). The software (104) may include an operating system. An operating system allows other applications to interact properly with the hardware of the physical computing system. The other applications may include a conference queuing application. The data (106) may include information about participants to be queued using the conference queuing application.

A user interface (110) may provide a means for the user (112) to interact with the physical computing system (100). The user interface may include any collection of devices for interfacing with a human user (112). For example, the user interface (110) may include an input device such as a keyboard or mouse and an output device such as a monitor.

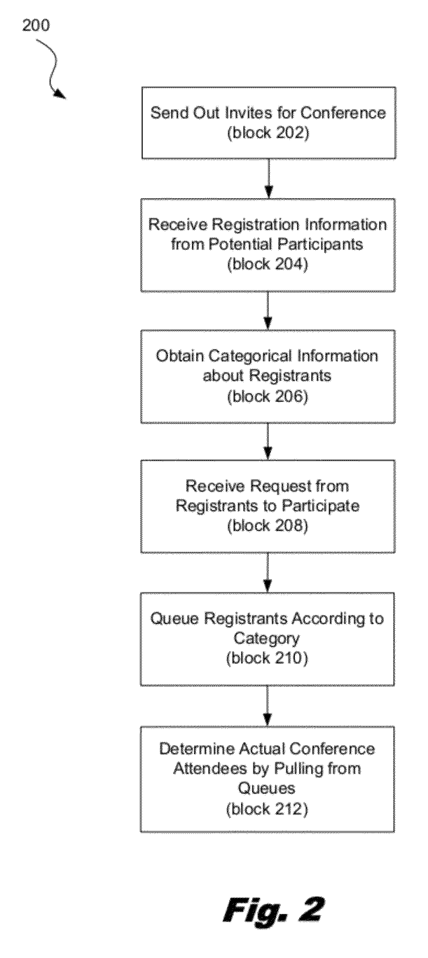

FIG. 2 is a flowchart showing an illustrative process (200) for queuing conference participants. According to certain illustrative examples, the process (200) begins when invitations to attend the conference are sent (block 202) out to potential participants. These invitations may be in the form of emails, text messages, phone calls, traditional mailings, and other forms of announcing or advertising a conference.

The moderator of the conference may control how many invitations are sent and to whom they are sent. In one example, the moderator may learn from past experience that about 10% of people who receive the invitation for the conference will actually register. Of those who register, only 20% may actually attend the conference. Thus, if the moderator is attempting to have a web conference of approximately 100 people, then he or she may send out 5000 invitations. In some cases, the conference attendance may be much smaller. Furthermore, some conferences, such as those held within an organization such as a business, may have a much higher percentage of people who will register and attend when receiving a request to join a conference.

In some cases, the invitations to join a web conference may be sent out automatically by the conference management system. For example, the moderator may provide the conference management system with a number of email addresses. These email addresses may have been obtained through an organization's database if the conference is for that organization. Alternatively, these email addresses may have been obtained from a database containing a list of people who may be interested in the web conference. For example, the moderator may be a business that wishes to provide a web conference for a number of their customers. The conference management system would then send out the invitations to those customers whose email addresses may be stored in a company database.

After sending out the invitations, the conference management system will then receive (block 204) registration information indicating who has registered for the conference. In one example, those who received invitations to join the web conference may use the Internet to go to a particular website that allows them to register for the conference. The website may ask for various credentials such as a name and a code that may have accompanied the invitation. The conference management system can then store the information of all those who have registered for the conference.

The conference management system will also obtain (block 206) categorical information about the registrants. This information will determine in which category a registrant should be placed. In one example, a registrant will be prompted to provide such categorical information when registering. For example, if the moderator wishes to control the percentage of attendees from various locations, then the registrant may be prompted to provide his or her relative geographic location.

Alternatively, the categorical information may be obtained from a database. For example, if the conference is a company web conference and the moderator wishes to manage the number of persons from different departments within the organization, then the conference management system may obtain this information from a database maintained by the organization. This database may store the names, departments, and other information which may be relevant for the conference management system when determining in which category a registrant should be placed.

At the time of the scheduled conference, the conference management system receives (block 208) the requests from the registrants to join the conference. For example, in the case of a web conference, the registrants may request to join the conference through the appropriate website. The conference management system will then queue (block 210) the registrants who have joined the conference according to their assigned category.

In some examples, there may be a time window in which the potential conference attendees attempt to join the conference and when the conference actually begins. For example, a web conference may be scheduled to start at 2:00. At 2:00, the registrants will begin to join the conference. However, the time between 2:00 to 2:10 may be designated as a waiting time in which the registrants “line up” in the queues. At 2:10, the meeting may actually begin.

When the meeting actually begins, the conference management system will determine (block 212) which registrants that are currently lined up in the queues will be allowed to join the conference. The conference management system will begin pulling from the queues until the predetermined criteria set by the moderator are satisfied. For example, the moderator may define a set number of people from each category to be allowed into the conference. In this case, the conference management will pull that set number from each category into the conference. The remaining registrants within the queue would then be denied access. All registrants may be notified of the possibility that they will not be allowed access to the actual conference based on the above described process.

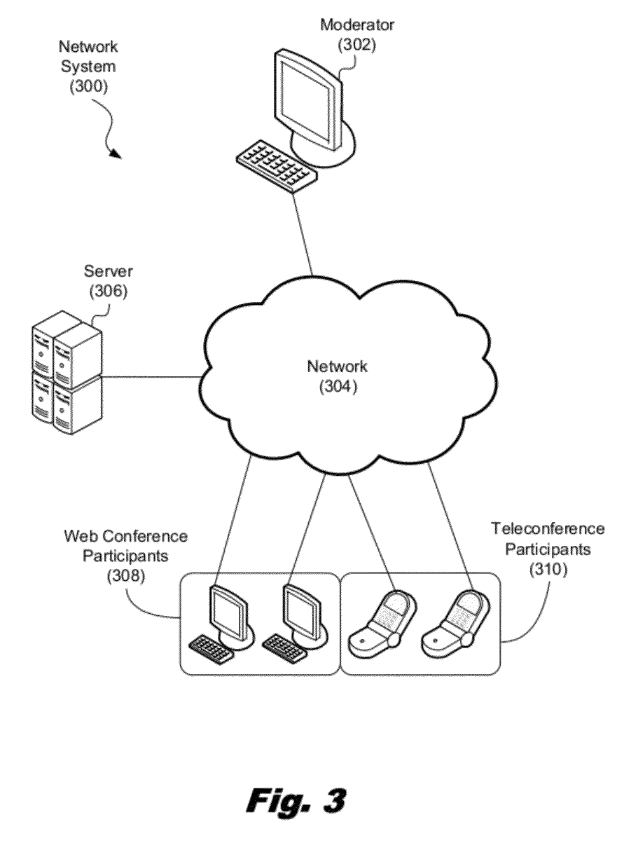

FIG. 3 is a diagram showing an illustrative network system (300) which may be used to run an application that queues conference participants. According to certain illustrative examples, the conference management system may be run on a server (306). The moderator (302) and conference participants (308, 310) may have access to the conference management system through a network (304) such as the Internet or a Local Area Network (LAN).

The conference management system may be designed to provide both web conferences and teleconferences. The moderator (302) may determine which type of conference is to be used. In the case of a teleconference, a registrant accesses the teleconference by calling in. The registrant may then identify himself or herself to the conference management system. This may be done by typing in a code provided to the registrant. The registrant will then be placed into a queue based on his or her categorical information. In some cases, a particular conference may host both web conference participants (308) and teleconference participants (310). Specifically, those accessing the conference through the Internet may obtain both video and audio coverage of the conference. Those accessing the conference by phone may obtain only audio coverage.

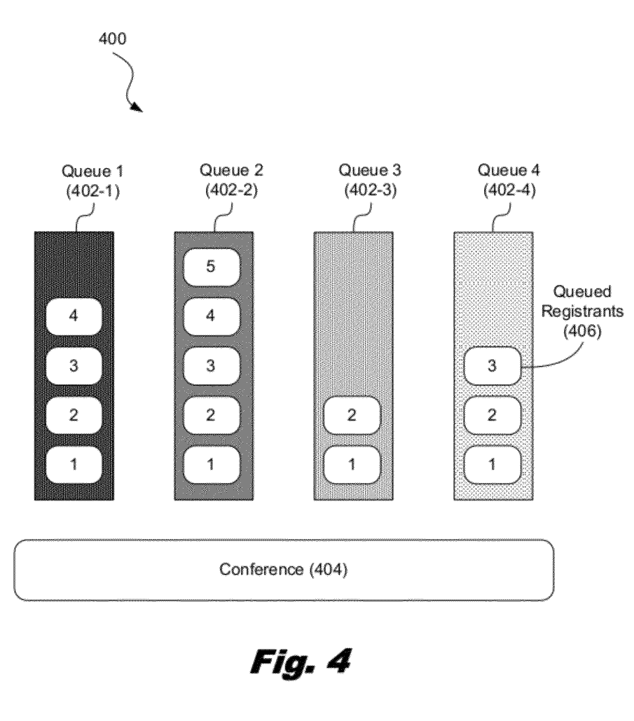

FIG. 4 is a diagram (400) showing an illustrative set of queues for a conference (404). According to one illustrative example, a moderator may define four different categories in which registrants may be placed. Four different queues will then be used, one for each of the four different categories. When a registrant attempts to access the conference (404) before the actual conference start time, then that registrant will be placed in the appropriate queue.

In the example of FIG. 4, queue 1 (402-1) includes four registrants (406), queue 2 (402-2) includes five registrants (406), queue 3 (402-3) includes two registrants, and queue 4 includes three registrants (406). As new registrants attempt to join the conference (404), they will be placed into the appropriate queue (402).

According to certain illustrative examples, the order in which registrants are placed into the queue may depend upon the time at which those registrants attempted to access the conference. Specifically, those who first attempted to access the conference may be placed first in the queue. In some cases, some registrants may be given preference based on criteria defined by the moderator. For example, the moderator may have sent out some invitations that offered the registrant a priority in the queue if he or she accepted the invitation by a certain time.

In some cases, a registrant may belong to more than one category based on his or her characteristics. For example, a moderator may wish to have a certain percentage of attendees from certain geographic location as well as a certain mix of male and female attendees. Thus, a registrant will fall into two categories. One category would be for geographic location and the other category would be for gender. In this case, the conference management system may be configured to put a particular registrant in two queues. When the conference starts, the conference management system will take into account both characteristics when pulling in registrants from the queues to join the conference. Particularly, the conference management system will pull in participants in a manner that best meets the criteria defined by the moderator.

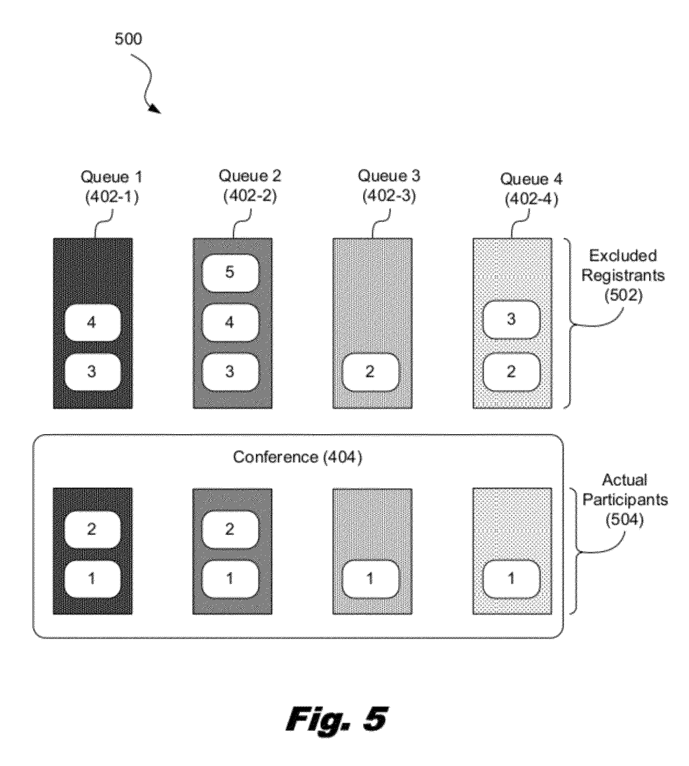

FIG. 5 is a diagram (500) showing an illustrative set of queues and participants who have been allowed into a conference (404). FIG. 5 illustrates the actual conference participants after the conference management system has pulled in the appropriate number of participants from the queues (402) in order to meet the moderator defined criteria.

In one example, the moderator criteria may specify a specific that the moderator desires a specific amount of participants from each queue. For example, the moderator may wish to have two participants from queue 1 (402-1), two participants from queue 2 (402-2), one participant from queue 3 (402-3) and one participant from queue 4 (402-4). In this case, the conference management system would pull in the first one or two participants (504) from each of the queues and exclude the remaining registrants (502).

In some cases, there may not be enough participants in the queue to meet the criteria. For example, the moderator may wish to have four persons from a particular queue. If only three registrants line up in that queue, then the conference may still start as planned. However, if a registrant attempts to access the conference after it has already started and is placed into that queue that still needs a fourth person, then that late registrant may be immediately allowed to access the conference.

According to certain illustrative examples, a moderator may wish to have a certain percentage of participants from each queue. For example, the moderator may wish that ⅓ of the participants be from queue 1 (402-1), ⅓ of the participants be from queue 2 (402-2), ⅙ of the participants be from queue 3 (402-3), and ⅙ of the participants be from queue 4 (402-4). FIG. 5 illustrates the case where such a percentage has been allowed into the conference. If the appropriate number of registrants currently within each of the queues can be added without adjusting the percentage, then the conference management system may add those registrants to the conference. In this case, two participants from queue 1 (402-1), two participants from queue 2 (402-2), one participant from queue 3 (402-3) and one participant from queue 4 (402-4) can be added to the conference without affecting the moderator defined percentage.

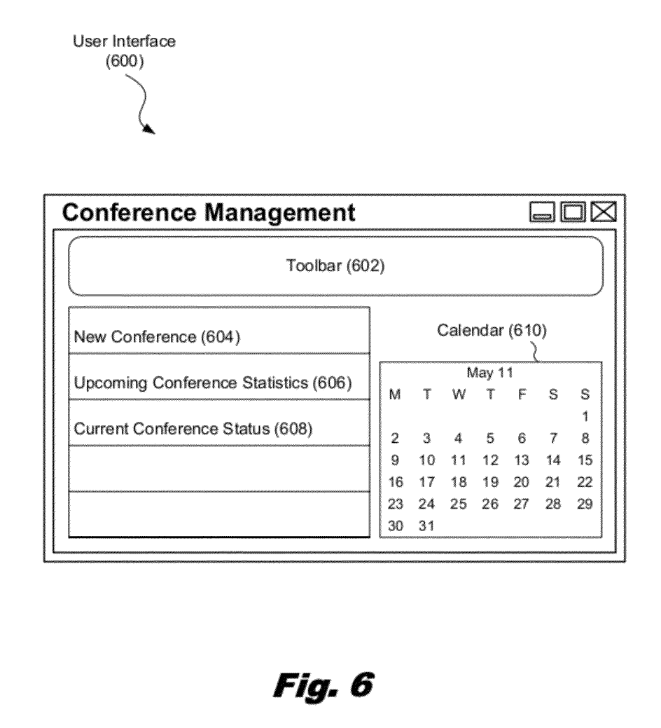

FIG. 6 is a diagram showing an illustrative user interface (600) for managing an application for queuing conference participants. This interface may be available to a conference moderator who sets up and manages the demographics of a conference. According to certain illustrative examples, the user interface (600) includes a toolbar (602), a new conference control (604), an upcoming conference statistics control (606), a current conference status control (608), and a calendar display (610).

The toolbar (602) may provide the user with a number of tools that are typically associated with user interfaces. The calendar display (610) may provide the user with a view of the current day, week, or month. The user may be able to visually see upcoming or even recently passed conferences.

The new conference control (604) allows a moderator to create a new conference. Through this control the moderator may schedule a new conference and define the criteria for that conference. Specifically, the user may select which categories should be used by the conference and what number or percentage of each category should be allowed into the actual conference. Through this control (604), the moderator may also define who should be invited to the conference. The invitations may then be sent out according to the moderator's defined mode of delivery such as email or text message.

Through this control (604), the moderator may also setup and define categories for the new conference. The moderator may also define the method of obtaining information about registrants that will allow the placement of those registrants into appropriate categories. For example, the moderator may indicate whether or not information should be obtained by prompting the registrant or from a database that may contain the desired information.

The upcoming conference statistics control (606) can allow a moderator to see how many people have received invitations for an upcoming conference and how many invitees have actually registered. Furthermore, the moderator may view various statistics about those who have registered. Particularly, the moderator can view how many of the registrants belong to particular categories.

The current conference status control (608) may display to the moderator the statistics of a conference in progress. Specifically, the control (608) may bring up a window that displays how many registrants are currently lined up in the queues and waiting for the conference to start. If the conference has already started, the moderator may see the demographics of the actual conference participants and see how closely those demographics match the criteria defined by the moderator.

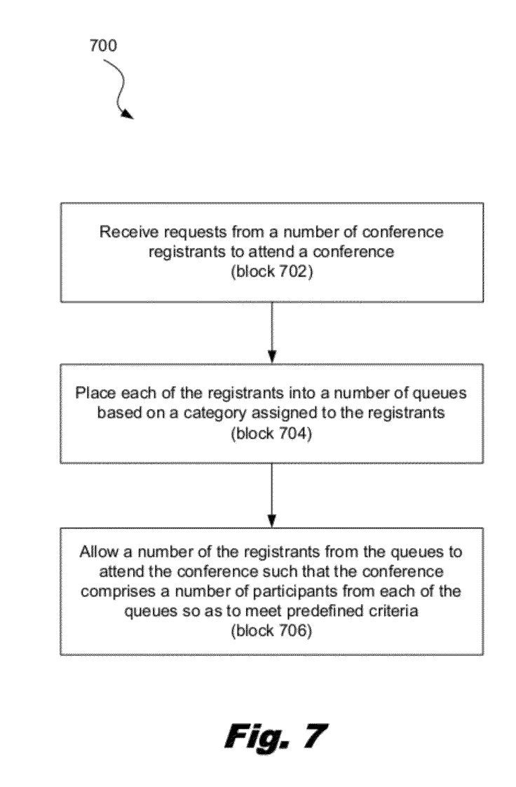

FIG. 7 is a flowchart showing an illustrative method (700) for queuing conference participants. According to certain illustrative examples, the method includes receiving (block 702) requests from a number of conference registrants to attend a conference, placing (block 704) each of the registrants into a number of queues based on a category assigned to the registrants, and allowing (block 706) a number of the registrants from the queues to attend the conference such that the conference comprises a number of participants from each of the queues so as to meet predefined criteria.

In conclusion, through use of methods and systems embodying principles described herein, a moderator may define the mix of characteristics that he or she desires to be present within a conference such as a web conference or a teleconference. This provides the moderator with more control over the demographics of the meeting. This can be helpful if the subject matter to be presented at the conference is designed for a specific mix of demographics.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method for queuing conference participants by category, the method comprising:
with a physical computing system, receiving requests from a number of conference registrants to attend a conference;
with said physical computing system, placing each of said registrants into a number of queues based on a category assigned to said registrants; and
with said physical computing system, allowing a number of said registrants from said queues to attend said conference such that said conference comprises a number of participants from each of said queues so as to meet predefined criteria.

2. The method of claim 1, wherein a category of each registrant is obtained by prompting that registrant during a registration process.

3. The method of claim 1, wherein a category of each registrant is obtained based on an identification of that registrant and a database comprising categorical information about that registrant.

4. The method of claim 1, wherein said physical computing system comprises an internet server that provides a web conference service.

5. The method of claim 1, wherein said predefined criteria is provided by a moderator of said conference.

6. The method of claim 1, wherein said predefined criteria is a set number of participants from each queue.

7. The method of claim 1, wherein said predefined criteria is a percentage of total participants from each queue.

8. The method of claim 1, further comprising:
with said physical computing system, receiving an additional request from a late registrant to join said conference after said conference has already started; and
with said physical computing system, adding said late residence to said conference if allowing said late resident would comport with said predefined criteria.

9. The method of claim 1, wherein said conference is one of: a teleconference and a web conference.

10. The method of claim 1, wherein said categories for said queues comprise at least one of: skills, a position within an organization, ethnicity, gender, a geographic location, and a business unit.

11. A computing system comprising:
a processor; and
a memory communicatively coupled to said processor;
in which said processor is configured to:
receive requests from a number of conference registrants to attend a conference;
place each of said registrants into a number of queues based on a category assigned to said registrants; and
allow a number of said registrants from said queues to attend said conference such that said conference comprises a number of participants from each of said queues so as to meet predefined criteria.

12. The system of claim 11, wherein a category of each registrant is obtained by prompting that registrant during a registration process.

13. The system of claim 11, wherein a category of each registrant is obtained based on an identification of that registrant and a database comprising categorical information about that registrant.

14. The system of claim 11, wherein said physical computing system comprises an internet server that provides a web conference service.

15. The system of claim 11, wherein said predefined criteria is provided by a moderator of said conference.

16. The system of claim 11, wherein said predefined criteria is a set number of participants from each queue.

17. The system of claim 11, wherein said predefined criteria is a percentage of participants from each queue.

18. The system of claim 11, wherein said processor is further configured to:
receive an additional request from a late registrant to join said conference after said conference has already started; and
add said late residence to said conference if allowing said late resident would comport with said predefined criteria.

19. The method of claim 1, wherein said conference is one of: a teleconference and a web conference.

20. A computer program product for queuing conference participants, said computer program product comprising:
a computer readable storage medium having computer readable code embodied therewith, said computer readable program code comprising:
computer readable program code configured to receive requests from a number of conference registrants to attend a conference;
computer readable program code configured to place each of said registrants into a number of queues based on a category assigned to said registrants; and
computer readable program code configured to allow a number of said registrants from said queues to attend said conference such that said conference comprises a number of participants from each of said queues so as to meet predefined criteria.
